(19) United States
(12) Patent Application Publication
(10) Pub. No.: US 2005/0049894 A1
(43) Pub. Date: Mar. 3, 2005

(54) System and method of managing business processes

(75) Inventors: Robert Wayne Cantwell, San Antonio, TX (US); Daniel Bishop, San Antonio, TX (US); Daniel Gerard Mascorro, San Antonio, TX (US); Rajesh Sreedharan, Chennai (IN); Rajesh Shastri, Nagpur (IN); Usha Lakshamanan, Chennai (IN)

Correspondence Address: William B. Nash;JACKSON WALKER L.L.P., Suite 2100, 112 E. Pecan Street, San Antonio, TX, 78205, US

(73) Assignee: United Services Automobile Association (USAA)

(21) Appl. No.: 10/927,255

(22) Filed: Aug. 26, 2004

Related U.S. Application Data
(60) Provisional application No. 60/498,382, filed on Aug. 27, 2003.

(51) Int. Cl. G06F 17/60

(52) U.S. Cl. 705/1; 705/7

(57) ABSTRACT

The present invention provides a system and method utilizing a plurality of software driven externalized rules capable of defining tasks associated with a particular business process as well as presentation information to be displayed upon one or more user interfaces associated with each task. In one embodiment, software driven externalized rules are used to define one or more generic task definitions which may then be applied to product specific information including customer information, product information, and geographical information. In another embodiment, the present invention provides a system and method for minimizing risks associated with providing one or more insurance products. This feature of the present invention allows authorized users to alter the availability of one or more products likely to be impacted by an event. Users may be advised of the alteration via textual and or graphical information displayed upon a user interface.

This utility application is based upon and claims priority on a U.S. Provisional Application entitled “Product Administration System”, Ser. No. 60/498,382, having a filing date of Aug. 27, 2003.

### FIELD OF THE INVENTION

The present invention relates generally to process management and, more particularly, to a method of managing business processes in an electronic environment.

### BACKGROUND OF THE INVENTION

Electronic business processes typically require the execution of a great deal of individual tasks. Depending upon the requirements and applicability of each task, the number of tasks to be executed for any given business process may vary. This is especially true regarding online business processes.

Rules and/or guidelines may be utilized in order to manage which tasks are to be executed and in what order. Known hard-coding techniques provide structure for business process execution but are exceptionally rigid in their design. As such, hard-coded process rules do not allow for flexibility in that they must be re-coded each time an alteration of the business process is required. Such changes are often expensive and subject to programming errors.

There remains a need for a system and method capable of managing business processes without the disadvantages associated with known hard-coding techniques. Further, there remains a need for a system and method capable of managing business processes associated with one or more insurance products.

### SUMMARY OF THE INVENTION

Accordingly, the present invention provides a system and method capable of managing business processes in a flexible and cost effective manner. In one embodiment, the present invention utilizes a plurality of software driven externalized rules capable of defining tasks associated with a particular business process as well as presentation information to be displayed upon one or more user interfaces associated with each task. The externalized rules of the present invention are designed to facilitate interaction with individual users as well as provide an efficient mechanism for amending business process functionality.

The present invention further provides a generic definition feature designed to provide consistency along multiple lines of business. In one embodiment, software driven externalized rules are used to define one or more generic task definitions which may then be applied to product specific information including customer information, product information, and geographical information. As such, each generic task definition need only be defined once, thus saving storage space and enhancing the efficiency of each business process.

In one embodiment, the present invention provides a system and method for minimizing risks associated with providing one or more insurance products. This suspension feature of the present invention allows a system administrator to alter the availability of one or more products impacted by an event. In one embodiment, users may be advised as to the amendment alteration via textual and or graphical information displayed upon a user interface.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawing; it being understood that the drawings contained herein are not necessarily drawn to scale; wherein:

FIG. 1 is a component diagram illustrating one embodiment of the present invention.

FIG. 2 is a screen shot illustrating the administrator user interface of one embodiment of the present invention.

FIG. 3 is a process flow diagram illustrating the product definition and display process of one embodiment of the present invention.

FIGS. 4 and 5 are screen shots illustrating the product definition user interface of one embodiment of the present invention.

FIG. 6 is a process flow diagram illustrating the search/report process of one embodiment of the present invention.

FIGS. 7-10 are screen shots illustrating the search/report graphic user interface of one embodiment of the present invention.

FIG. 11 is a process flow diagram illustrating the suspension process of one embodiment of the present invention.

FIGS. 12-14 are screen shots illustrating the suspension user interface of one embodiment of the present invention.

### DETAILED DESCRIPTION OF THE INVENTION

The present invention is herein described as a system and method of managing the operation of one or more electronic business processes and as a system and method of minimizing the risk associated with providing one or more insurance products.

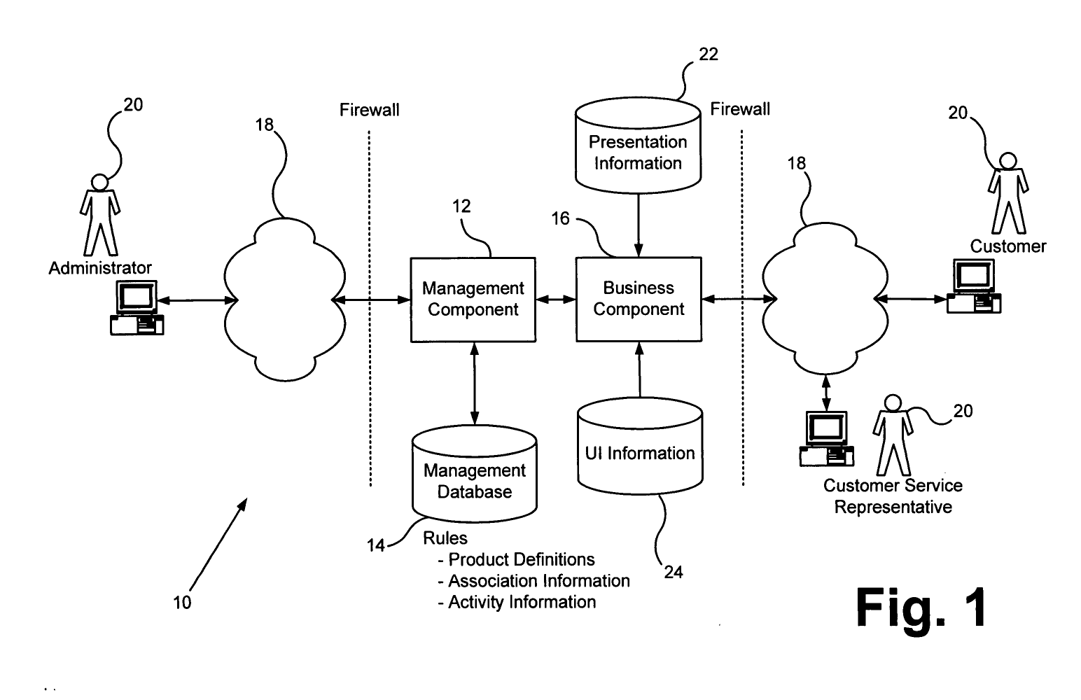

Referring to FIG. 1, the present invention comprises a management system (10) having at least one management component (12) coupled to at least one management database (14). In one embodiment, the management database of the present invention contains externalized rules and/or definitions for defining tasks associated with one or more business processes.

The management component (12) of the present invention is coupled to one or more business components (16) capable of interacting with individual users (20) via a computer network (18). In one embodiment, the present invention utilizes a series of software driven subroutines designed to facilitate interaction between the management component, the business component, various storage devices, and the user. In order to access the unique capabilities of the present invention, a user need only access a URL address through a computer network (18), such as the internet. In one embodiment, security infrastructure is utilized to provide security against unauthorized access and/or harmful viruses.

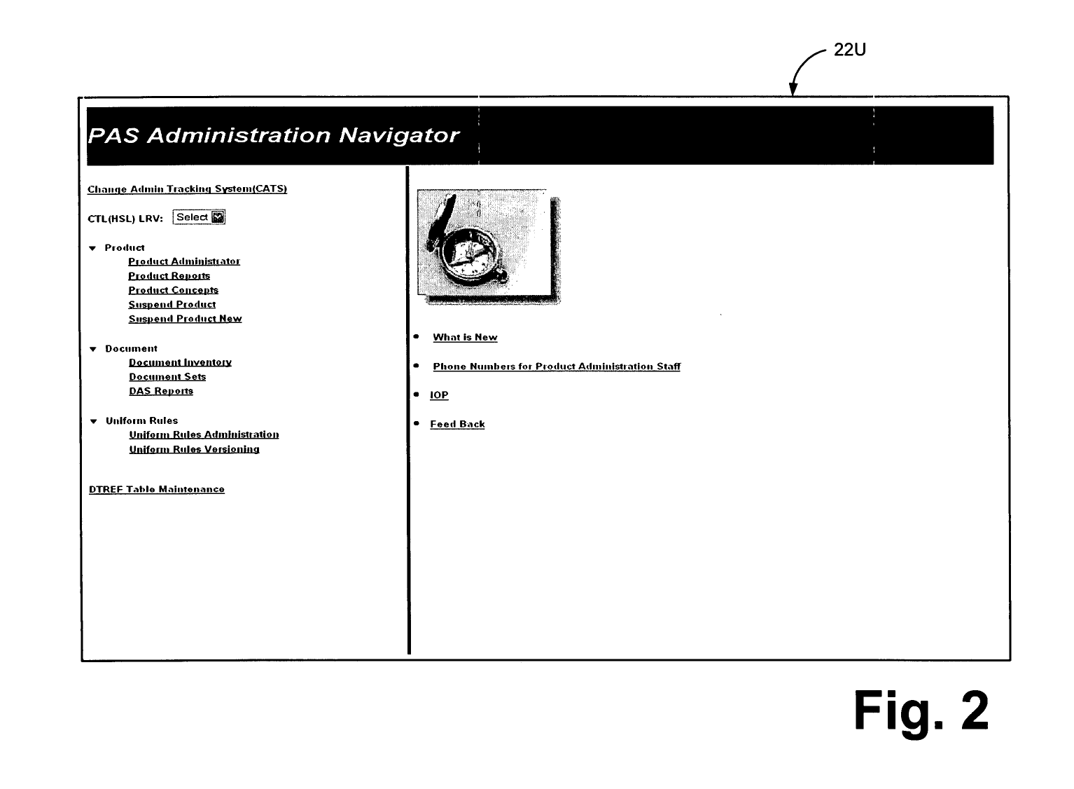

Referring to FIGS. 1 and 2, the present invention is designed to allow authorized users or administrators to access the management component (12) in order to add, modify, or delete externalized rules held upon the management database (14). The present invention provides an administrator user interface (22U) for facilitating interaction with the system. In one embodiment, the administrator may access the management component (12) and the management database (14) via a computer network (18) using a web browser. Once his or her authorization code(s) have been accepted, the administrator may review and/or edit the externalized rules governing the system's interaction with other users, i.e., customer service representatives (CSRs) and customers.

The use of externalized rules allows for dramatic flexibility during business process execution, creation, and maintenance. For example, changes no longer have to be made to the business processes themselves, only to the externalized rules held upon one or more management databases (14). In short, the use of externalized rules instead of hard-coding into each individual business process allows each task to be amended quickly and easily through changes to the software comprising the rules. This feature of the present invention also allows each task to be independent and reusable for more than one business process.

The externalized rules provided by the present invention serve a number of purposes in addition to business process task definition. In one embodiment, the externalized rules of the present invention are designed to associate stored presentation information (22) and/or one or more user interfaces with each task. This allows information relating to a particular business process and/or user inputs to be retrieved quickly and efficiently. In this manner, the present invention allows for the display of relevant presentation information upon the appropriate user interface for review by the user. Further, the externalized rules may be utilized to alter and/or vary the manner in which such information is displayed.

Interaction with system users may be facilitated by java servlets and/or JAVA server pages (JSP). In one embodiment, web server and application server technology such as a server farm of Intel Pentium 4/MS Windows servers running Apache Http Server on Linux operating systems and IBM midrange servers running Websphere Application Server or BEA's Weblogic Server on AIX operating systems may be utilized by the present invention to facilitate user interaction. It being understood that this is an illustrative example only and that any number of hardware configurations may be utilized.

In one embodiment, stored presentation information (22) may be defined as textual and/or graphical information relating to or associated with a business transaction. Such information may be displayed upon separate user interfaces or upon the same user interface in order to provide the user with multiple information sets at the same time. For example, in an insurance environment, the present invention may display instructions, data entry fields, and other fields related to the entry and evaluation of home and/or vehicle insurance. This information may be supplemented and/or augmented with information relating to particular tasks associated with each vehicle insurance business process. User interface information may be stored upon one or more databases (24) coupled to the system. In one embodiment, the present invention stores activity information relating to each user interaction upon one or more storage devices coupled to the system. In this manner, the system maintains records of the system's activities for future use.

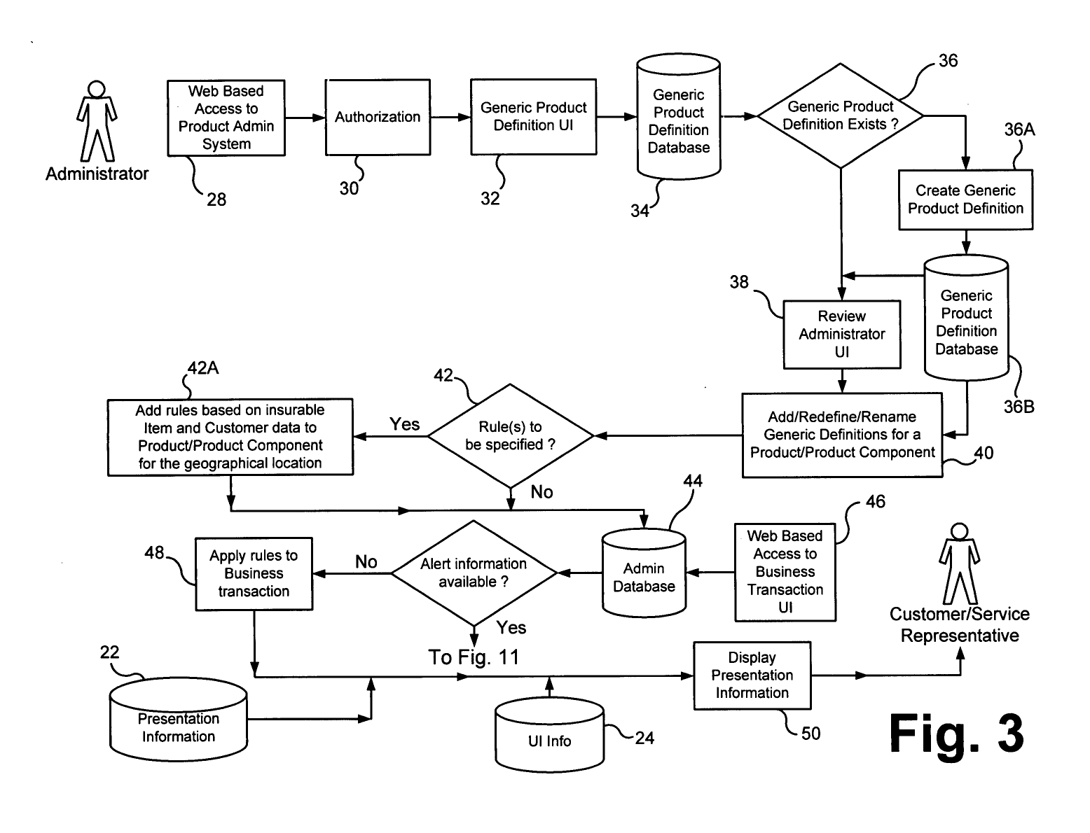

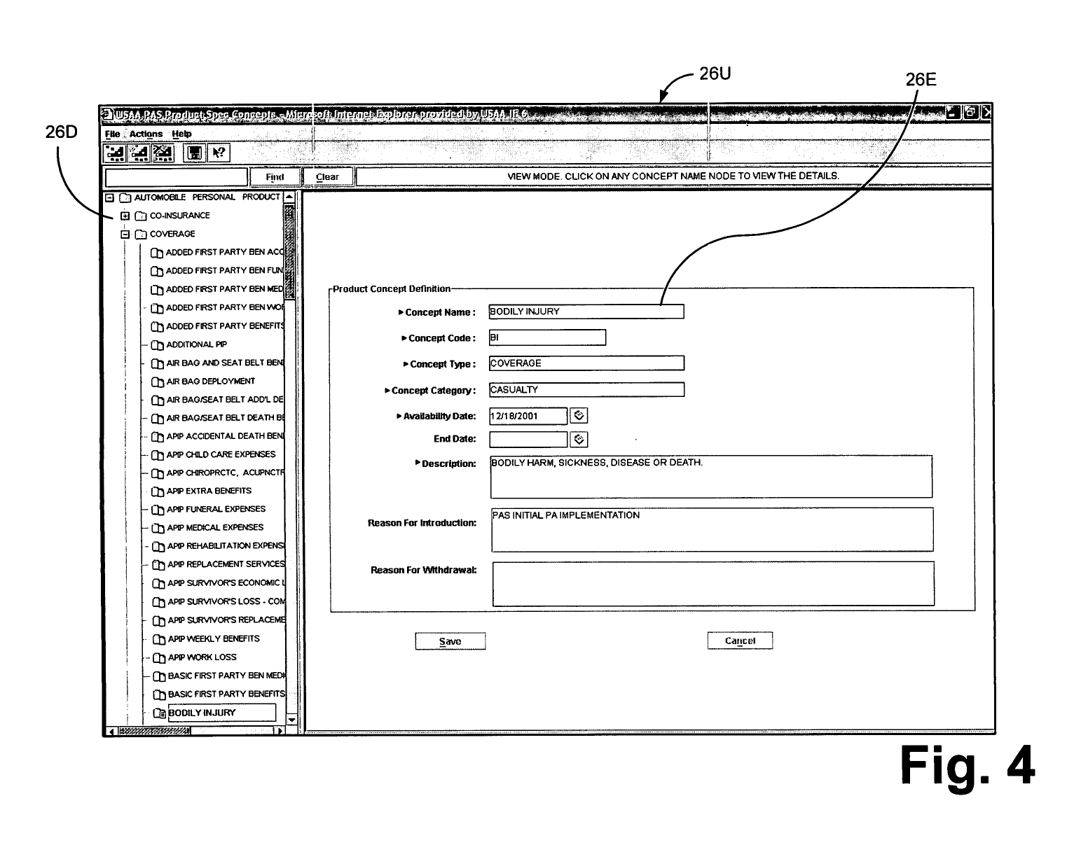

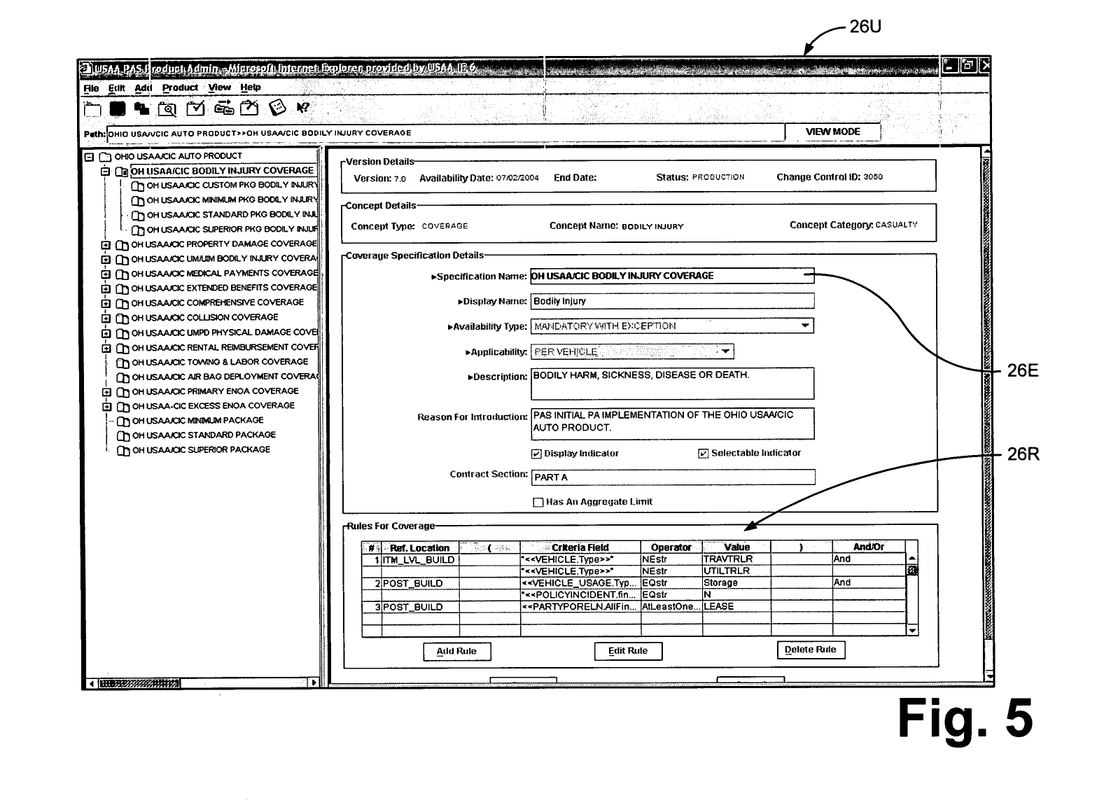

Referring to FIGS. 3-5, in one embodiment, the present invention provides externalized rules defining one or more generic definitions. Products common to one or more business processes may be defined and given a generic identifier. For example, in the insurance industry, each State requires liability insurance and other standard coverage. However, every State has its own unique way of naming and defining the coverage required.

Instead of defining specific product definitions for each individual product, the present invention provides a plurality of generic product definitions, each applicable to multiple products. These generic definitions may be utilized repeatedly for various insurance products and redefined according to any number of factors relating to the particular product at issue. In one embodiment, transaction specific information is utilized to redefine one or more generic definitions to comply with naming conventions required by each particular State or geographical region. Such information may take the form of information relating to a particular customer, the product at issue, and/or the geographical location of the product, the customer, or both.

In this example, the product is generically defined by the externalized rules and stored upon a storage device coupled to the system. Each generic product definition may be applied to a particular customer or product and redefined according to information relating to each particular transaction. Stored naming convention information relating to individual products, persons, and/or geographical locations may be utilized by the present invention to redefine generic product definitions. In one embodiment, stored naming convention information is maintained in tabular format upon a generic product definition table.

Authorized administrators may access the system through use of a web browser, as illustrated by Boxes 28 and 30. Through the web browser, the access the product definition interface (26U) through which he or she may create, maintain, and/or amend generic product definitions (26D), as illustrated by Boxes 32, 34, 36, 36A and 36B.

For example, if a State agency decides to amend or augment its insurance requirements, the administrator may quickly and easily institute this change into the system. In one embodiment, the product definition interface provides data entry fields and/or drop down tabs (26E) for use by the administrator in creating, maintain, and/or amending generic product definitions.

As described above, administrators may review, amend and/or redefine product definitions based upon information relating to a particular product, customer, or geographical area, as illustrated by Boxes 38 and 40. Additional product rules (26R) relating to the redefined product definition may also be entered into the system, as illustrated by Boxes 42 and 42A. Such rules are then associated with their respective product definition(s) and stored for later use, as illustrated by Box 44.

Once defined, product definitions may be applied to individual business transactions initiated by customers or CSRs accessing the system through a web browser, as illustrated by Box 46. Product rules defining the product and/or transaction are then utilized to manage the presentation of information to the user upon the user interface, as illustrated by Boxes 48 and 50.

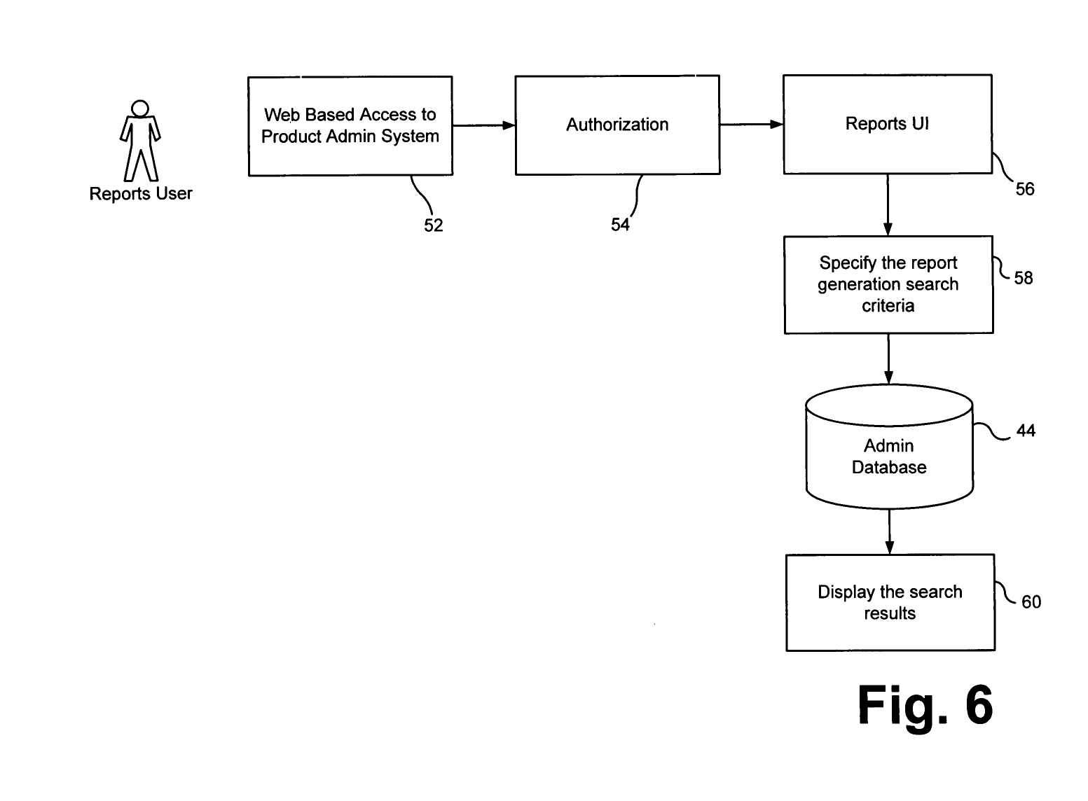

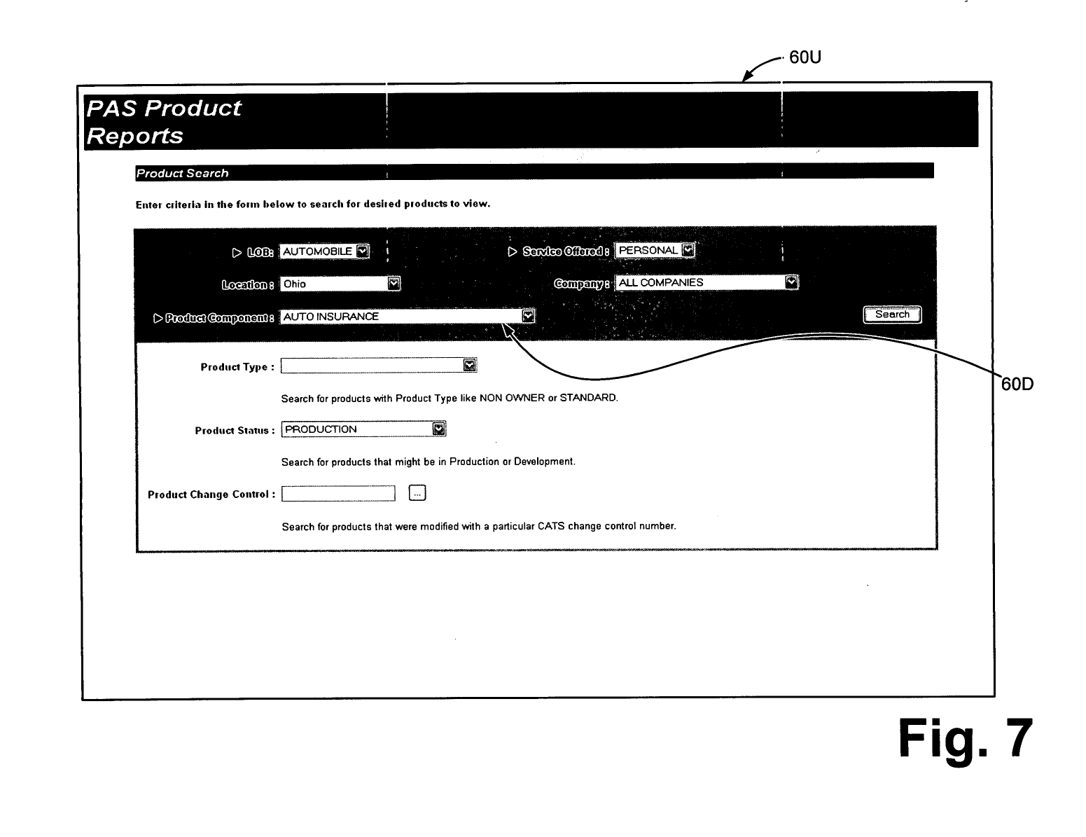

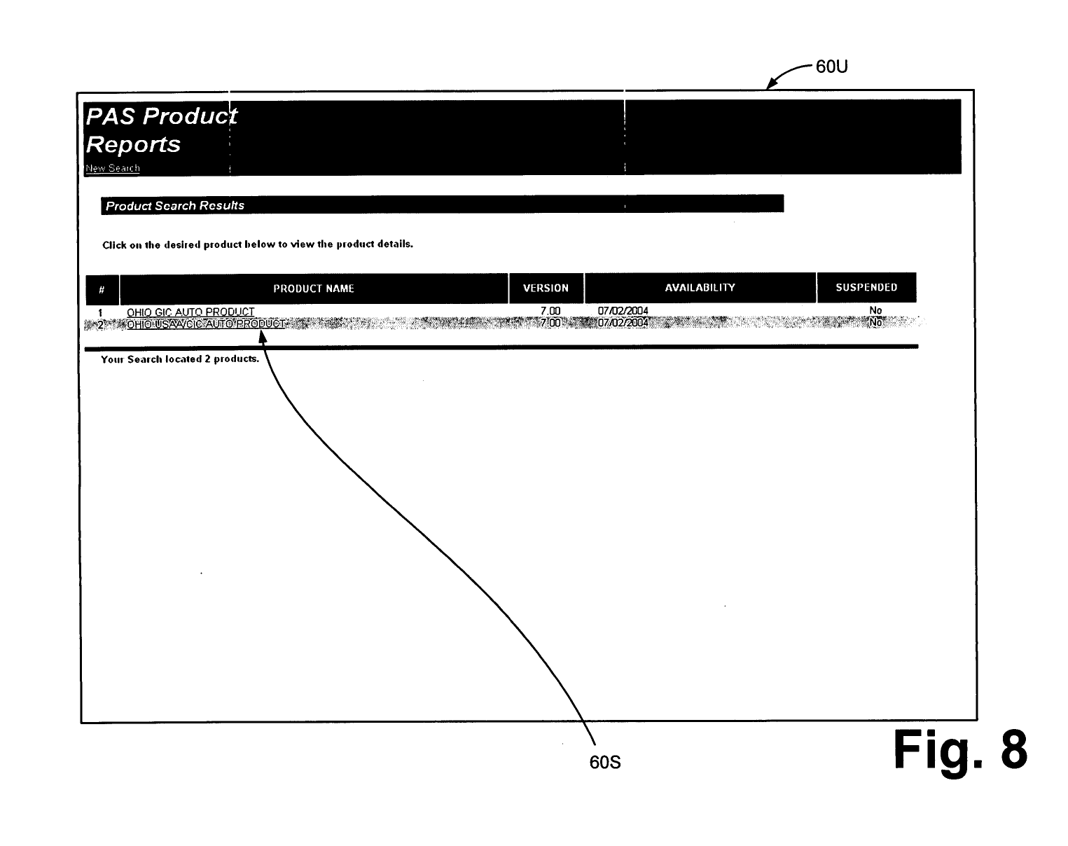

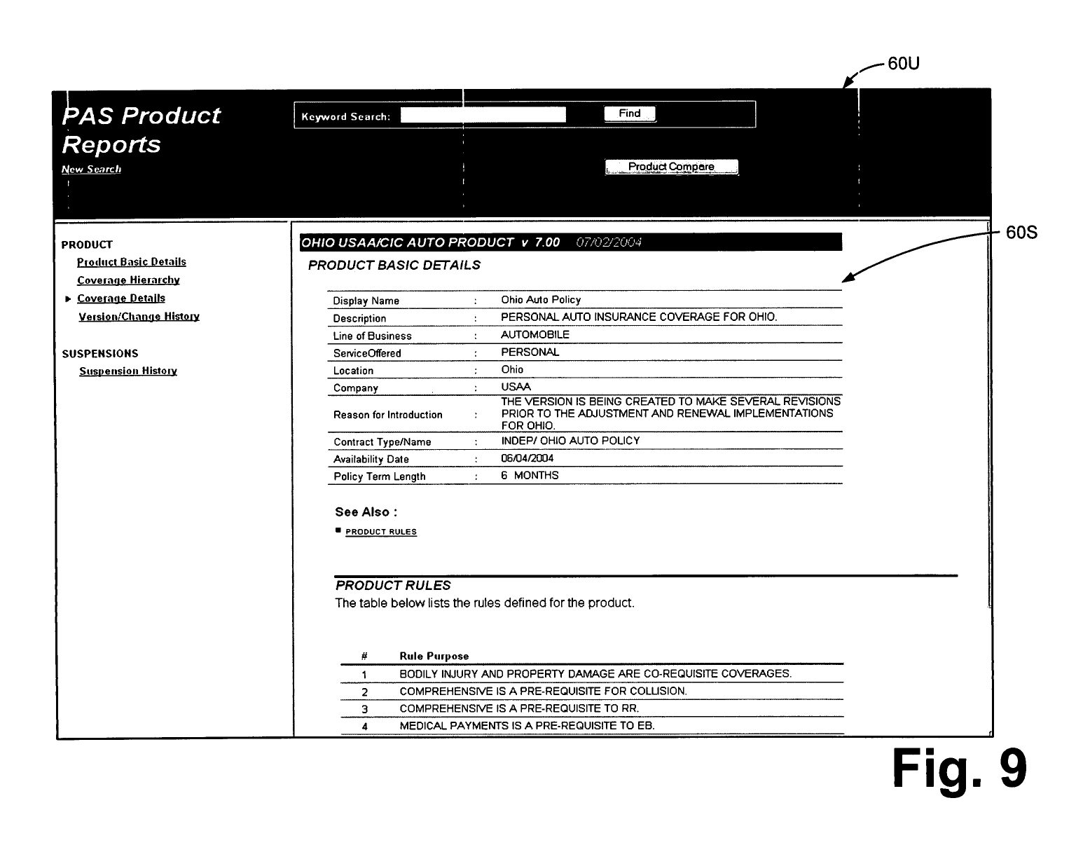

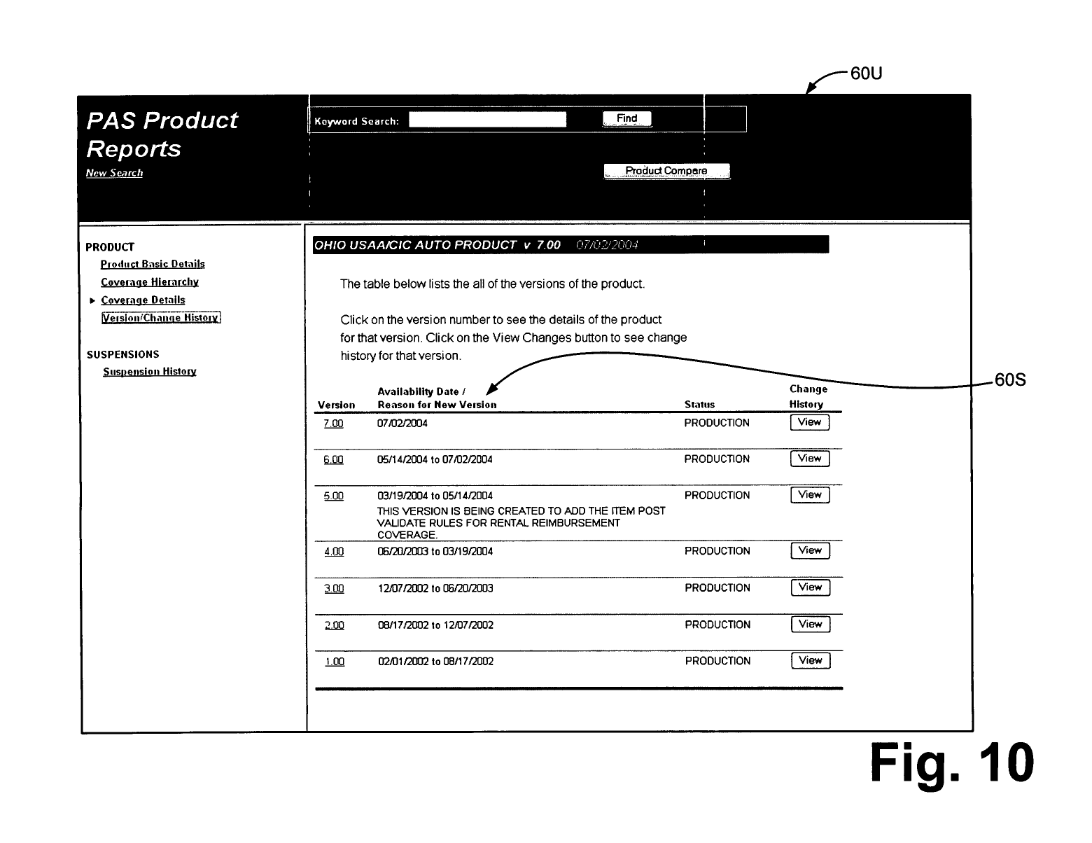

Referring to FIGS. 6-10, the present invention provides search and report functionality for use in managing a plurality of business processes. The present invention allows authorized users, including administrative personnel, to search information held upon one or more databases utilized by the system. In one embodiment, the present invention provides a software driven search and report utility having at least one user interface (60U) through which the user may enter search parameters and review search results (60S). In one embodiment, the search and report utility of the present invention is accessible through a web browser coupled to a computer network.

In one embodiment, search parameters may be specifically tailored to provide the user with reports including tables, graphs, and other useful information. In this manner, the present invention allows the user to proactively define the format in which retrieved information is to be presented, as illustrated by Boxes 52-60 of FIG. 6. In one embodiment, the present invention provides a series of drop down tabs (60D) and/or free form text fields through which the user may define search and/or report parameters. In one embodiment, searchable information also includes system activity information stored upon one or more storage devices associated with the system.

The search/report capability of the present invention may also be utilized to provide the history and/or current status of any given business process or customer account. To illustrate, a customer service representative servicing an insurance customer will need to know any changes made to the customer's policy or other insurance products.

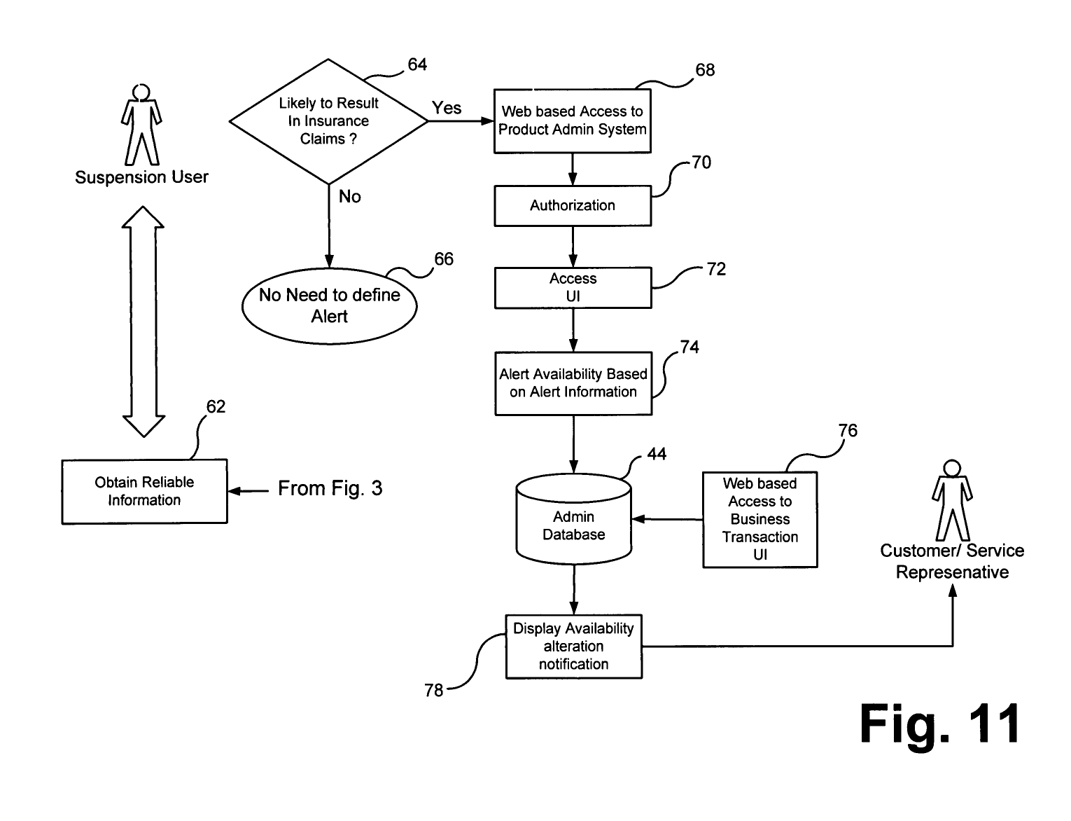

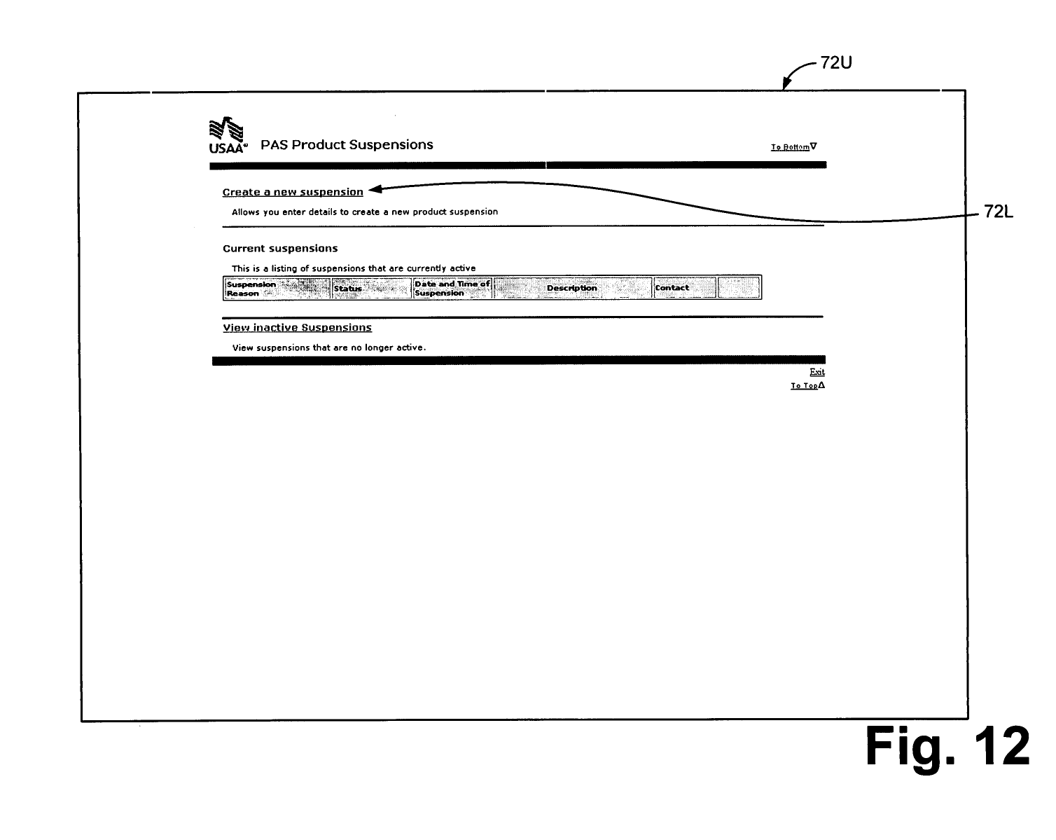

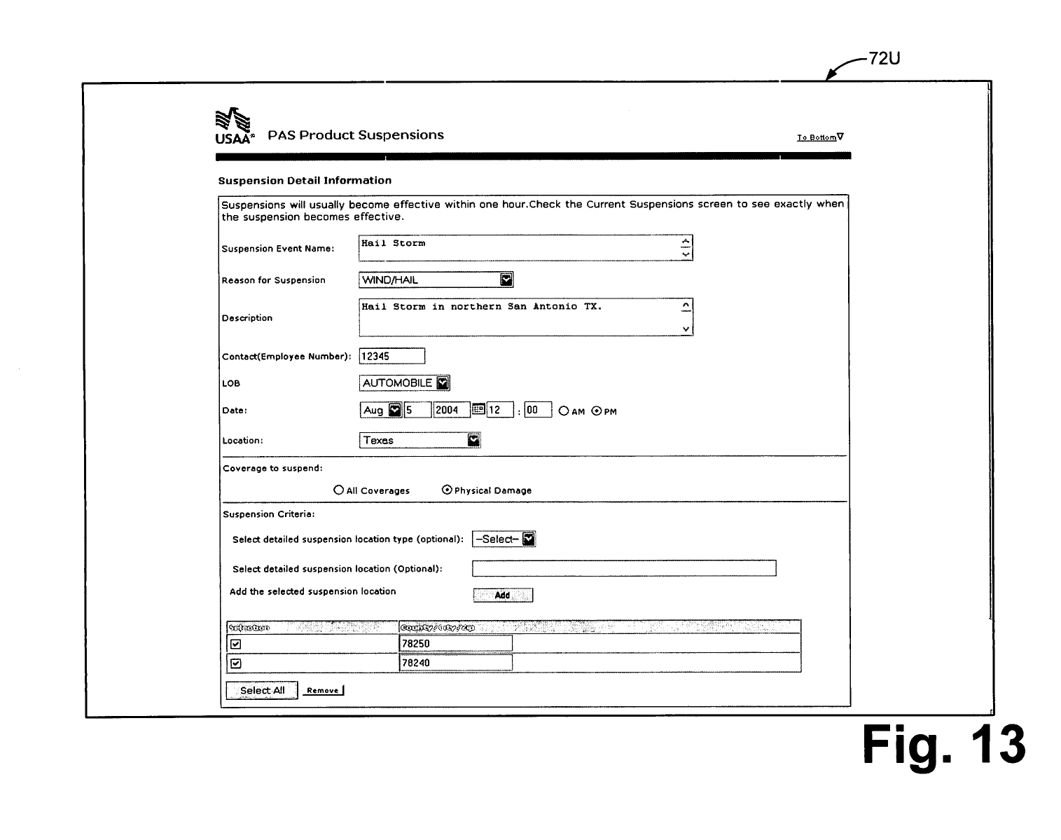

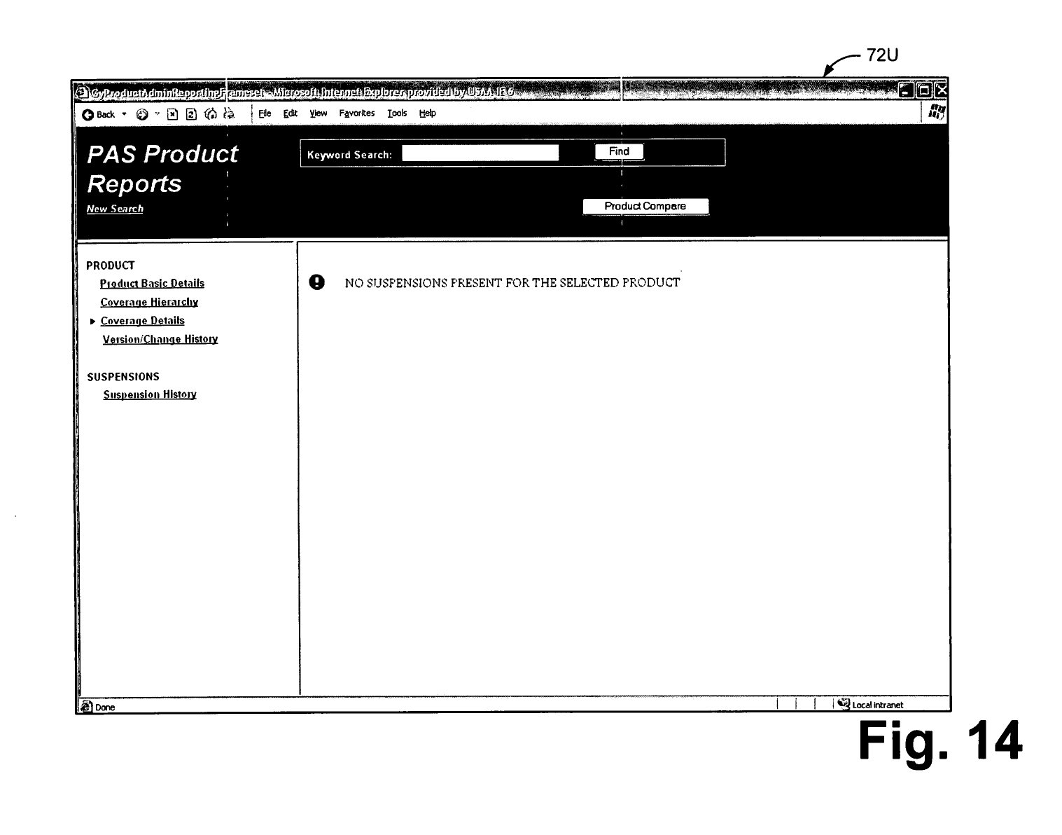

Referring to FIGS. 11-14, the unique functionality of the present invention is further capable of minimizing the risks associated with providing one or more products. Although the invention is described below in the context of providing insurance products, it should be understood that the present invention may be utilized in conjunction with any number of products, as would be apparent to one of ordinary skill in the art.

The present invention provides a system and method of minimizing risk utilizing one or more sources of information relevant to the product at issue. In the context of an insurance product, information relating to weather conditions, war, civil unrest, and/or any other event(s) which may result in an insurance claim is particularly important. Such information may be monitored by personnel and/or electronically accessed through a computer network, i.e., the Internet, in order to provide the system with immediate notification. In one embodiment, news sources/organizations may be automatically accessed over the Internet by a monitoring program provided by the present invention, as well as through use of e-mail alert notifications provided by such sources/organizations to authorized system users.

Upon receiving event information, the present invention accesses stored product information to determine which products and/or customers are likely to be affected by the event. This determination may be as simple as matching a particular product or customer to a geographical area likely to be affected by the event, i.e., the projected path of a hurricane. In other cases, this determination will require an analysis of both the event and its probable impact upon customers and their property.

Alert information is obtained and analyzed to determine if the event is likely to result in an insurance claim and/or adversely impact an insurance product provided by an organization, as illustrated by Boxes 62-72. In one embodiment, the present invention provides a user interface (72U) through which authorized personnel may access, analyze, and react to alert information. If the event in question is determined to be applicable to one or more products, an authorized user may alter the availability of the product(s) via the user interface (72U). In this manner, the present invention allows for an organization to minimize the risk associated with providing a particular product which may be adversely impacted by an event. For example, if it is widely reported that a hurricane is projected to strike the Florida coast, wily consumers may attempt to obtain additional insurance products, or additional coverage, just prior to the anticipated event. Clearly, providing customers with products insuring against the impending hurricane would not be in the best interests of the insurance organization.

In the past, organizations were forced to rely on individual customer service representatives to act on such information without a suitable reminder/enforcement mechanism. Unfortunately, customer service representatives are often quite busy and may forget to implement such directives.

As such, the present invention is capable of altering the availability of certain transactions when an event likely to result in an insurance claim has occurred or is about to occur. In one embodiment, the web browser provided by the present invention is coupled to at least one database (44) containing externalized rules for governing business transactions relating to the organization's products. An authorized user such as an administrator, is given access to the user interface (72U) of the present invention such that they may 1) enter new suspensions, 2) review current suspensions, and 3) view inactive suspensions. In one embodiment, links (72L) to supplemental user interface screens containing this information may be provided to the user.

An authorized user may alter the availability, i.e. suspend, one or more products through the user interface as illustrated by Box 74 of FIG. 11. Suspension information is then stored and made available to subsequent system users, as illustrated by Boxes 44, 76, and 78 of FIG. 11. In one embodiment, the risk minimization system of the present invention automatically searches for suspension information during each user encounter. If no suspension information applies to the user or product at issue, the system displays product information and/or policy data without an accompanying suspension notification, i.e. business is transacted as if no event had occurred, as illustrated by FIG. 3.

Suspension information may be provided to the user and, particularly, to customer service representatives, in any number of ways. In one embodiment, graphical and/or textual information may be provided upon the user interface (72U) in order to notify users that the availability of the product has been altered as well as the reason for any alteration. Further, transaction functionality for products and/or individual users likely to be affected by the event may be temporarily disabled to prevent high risk online transactions from taking place. In short, online transaction functionality may be “shut down” until the event in question has run its course. This feature of the present invention allows the system to keep users informed as well as minimizing the risk to the organization.

In one embodiment, the present invention utilizes at least one computer system having access to alert information. Authorized users may be assigned to multiple computer systems for the purpose of monitoring and analyzing alert information, as well as entering suspension information into the system via a web browser. In one embodiment, a plurality of computer systems may be strategically positioned according to geographical region. Referring to the above hurricane example, monitoring computer stations may be positioned in cities along the coastline of the United States in order to obtain easy access to both local and national information sources. In this manner, authorized users are placed in the best position from which to determine which events are likely to require entry of a suspension.

In one embodiment, each event and/or availability alteration entered into the system is incorporated into one or more electronic records. These records may then be stored upon one or more storage devices coupled to the system. In one embodiment, each record is associated with at least one customer and/or product so that event/availability information is made available to subsequent users. This feature of the present invention also provides each user with a history of events relating to each of his or her products.

As discussed above, entry of a suspension into the system is not necessarily automatic. As such, the authorized user or other personnel may be required to make a determination as to whether the event is 1) likely to adversely affect one or more products and/or 2) likely to result in one more insurance claims. Further, even if an event is likely to adversely affect a product or result in an insurance claim, the scope of any suspension entry may be limited to those products/customers having the highest risk of loss. In one embodiment, availability alterations are limited to those customers residing within geographical areas or having property within geographical areas having a high risk of being impacted by the event. This feature of the present invention allows the system to avoid unreasonably broad suspensions and reduces any potential risk of customer dissatisfaction.

Although the invention has been described with reference to specific embodiments, this description is not meant to be construed in a limited sense. Various modifications of the disclosed embodiments, as well as alternative embodiments of the invention, will become apparent to persons skilled in the art upon reference to the description of the invention. It is, therefore, contemplated that the appended claims will cover such modifications that fall within the scope of the invention.

1. A method of managing the operation of one or more electronic business processes comprising the steps of:
providing a plurality of externalized rules for:
defining one or more tasks for managing said business process;
associating stored presentation information with each task;
associating one or more user interfaces with each task; and
displaying said presentation information upon said user interface.

2. The method of claim 1, wherein said business process involves one or more insurance products.

3. The method of claim 2, wherein said externalized rules define one or more generic product definitions.

4. The method of claim 3, wherein said generic product definitions may be applied to transaction specific information selected from the group consisting of customer data, insurable item data, and geographical data.

5. The method of claim 3, wherein each of said generic product definitions are applicable to multiple insurance products.

6. The method of claim 5, further comprising the additional step of:
re-defining at least one of said generic product definitions as directed by naming convention information held upon a storage device.

7. The method of claim 6, wherein said naming convention information is stored upon a generic product definition table.

8. The method of claim 6, wherein said naming convention information is specific to one or more geographical regions.

9. The method of claim 1, further comprising the additional step of:
storing business process activity information upon one or more storage devices.

10. The method of claim 9, further comprising the additional step of:
providing a software enabled search and report utility coupled to said storage device, said utility having a second user interface through which users may enter search parameters and/or review search results.

11. A method of minimizing risk associated with providing insurance products comprising the steps of:
obtaining alert information relating to an event;
identifying one or more insurance products which may be adversely affected by said event; and
altering the availability of one or more of said insurance products.

12. The method of claim 11, further comprising the additional steps of:
determining whether said event is likely to result in one or more insurance claims; and
limiting said availability alteration to those events likely to result in one or more insurance claims.

13. The method of claim 11, further comprising the additional steps of:
determining a geographical area affected by said event; and
limiting said availability alteration to those customers residing within or having property within said geographical area.

14. The method of claim 11, further comprising the additional step of:
providing a computer system for accessing said alert information.

15. The method of claim 14, further comprising the additional step of:
providing a plurality of users for monitoring said events and entering said alert information into said system.

16. The method of claim 15, wherein said users are strategically positioned according to geographical region.

17. The method of claim 14, wherein said computer system is coupled to a global computer network, said network providing access to a plurality of reliable alert information sources.

18. The method of claim 14, further comprising the additional steps of:
creating one or more electronic records of said alteration;
storing said record upon a storage device coupled to said computer system.

19. The method of claim 11, further comprising the additional step of:
notifying one or more users of said alert information.

20. The method of claim 19, wherein said notification comprises graphical and/or textual information displayed upon a user interface.

21. A computer system for minimizing risk associated with providing insurance products comprising:
a processing unit for:
obtaining alert information relating to an event;
identifying one or more insurance products which may be adversely affected by said event; and
altering the availability of one or more of said insurance products.

22. The computer system of claim 21, wherein said processing unit is for determining whether said event is likely to result in one or more insurance claims and limiting said availability alteration to those events likely to result in one or more insurance claims.

23. The computer system of claim 21, wherein said processing unit is for determining a geographical area affected by said event and limiting said availability alteration to those customers residing within or having property within said geographical area.

24. The computer system of claim 21, wherein said processing unit is coupled to a global computer network, said network providing access to a plurality of reliable alert information sources.

25. The computer system of claim 21, wherein said processing unit if for notifying one or more users of said alert information.

26. The computer system of claim 25, wherein said notification comprises graphical and/or textual information displayed upon a user interface coupled to said processing unit.
